(19) United States
(12) Patent Application Publication
(10) Pub. No.: US 2016/0020615 A1
(43) Pub. Date: Jan. 21, 2016

(54) INCREASING THE PHASE TOLERANCE OF MAGNETIC CIRCUITS DURING CONTACTLESS ENERGY TRANSFER

(71) Applicant: PAUL VAHLE GMBH & CO. KG, Kamen (DE)

(72) Inventor: Faical TURKI, Bergkamen (DE)

(21) Appl. No.: 14/775,410

(22) PCT Filed: Mar. 10, 2014
(86) PCT No.: PCT/EP2014/054577

§ 371 Date: Sep. 11, 2015

(30) Foreign Application Priority Data
Mar. 12, 2013 (DE) 10 2013 004 179.1

(51) Int. Cl. H02J 5/00; H01F 38/14

(52) U.S. Cl. CPC H02J 5/005; H01F 38/14

(57) ABSTRACT

The invention relates to an inductive energy transfer system with a primary-side coil arrangement (L_{P}) and a secondary-side coil arrangement (L_{S}), which in each case together with capacities (C_{P}, C_{S}) form resonant circuits (RES_{P}, RES_{S}), characterised in that the primary-side coil system (SP_{P}) comprises two coils (L_{P}) connected in series, the connection point of which (P_{P}) is connected via a primary-side impedance (L_{PM}) with an input terminal (3) of the circuit (1) supplying the primary-side resonant circuit (RES_{P}) and/or in that the secondary coil system (SP_{S}) comprises two coils (L_{S}) connected in series, the connection point of which (P_{S}) is connected via a secondary-side impedance (L_{SM}) to an output terminal (4) of the circuit (2) downstream of the secondary-side resonant circuit (RES_{S}).

The present invention relates to an inductive energy transfer system with a primary-side coil arrangement and a secondary-side coil arrangement, which in each case together with capacities form resonant circuits.

In the case of contactless energy transfer, a good coupling between the primary-side and the secondary-side coil arrangement is important for the degree of effectiveness of the energy transfer. Insofar as energy should be transferred between a vehicle and a charging station, the charging station is most often placed on the ground, whereas the secondary-side pickup is mounted under the vehicle. The coil arrangements are most often formed by planar coils, whereby the charging station and the pickup can be formed in a plate-shaped manner. The magnetic coupling is in this regard substantially determined by the distance of the coil arrangements in the vertical direction as well as the horizontal offset thereof. The vertical distance is in this regard substantially predetermined by the vehicle type, whereas the horizontal offset of the coil arrangements to each other depends on the park position of the vehicle relative to the charging station.

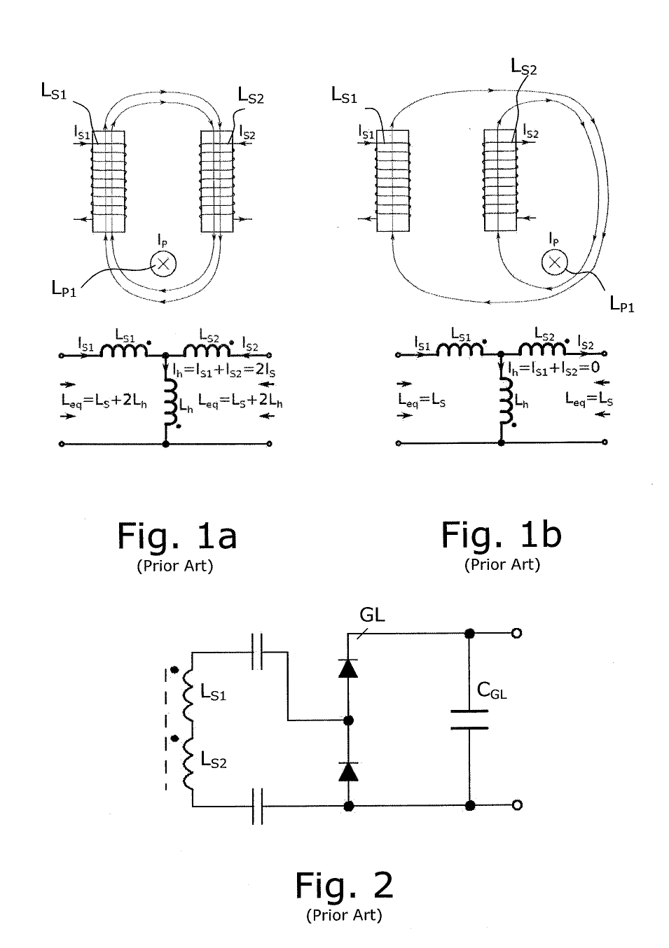

An attractive coil configuration for the secondary-side pickup is the double winding, consisting of the coils L_{S1} and L_{S2}, as it is depicted by way of example in FIG. 1a together with the associated equivalent circuit diagram. The primary-side charging station most often comprises a similar coil arrangement and is depicted in FIG. 1a merely by the conductor LP₁ with the current Iₚ flowing through the latter. In FIG. 1a, the primary and secondary-side coils are optimally arranged i.e. without horizontal offset to each other such that an optimal coupling results and the currents L_{S1} and L_{S2} flow in the secondary-side coils L_{S1} and L_{S2} in the push-pull operation. It lends itself in this regard to connect the coils L_{S1} and L_{S2} in series, as depicted in FIG. 2, since both currents L_{S1} and L_{S2} are in phase and equal in size. The magnetic coupling noticeably changes if the primary and secondary-side coil arrangements are offset horizontally to the optimal alignment according to FIG. 1a, as is depicted in FIG. 1b. In this case, the flow portions penetrating the two coils L_{S1} and L_{S2} are not phase-shifted by 180° to each other such that the coils L_{S1} and L_{S2} can no longer be connected in series, as depicted in FIG. 2.

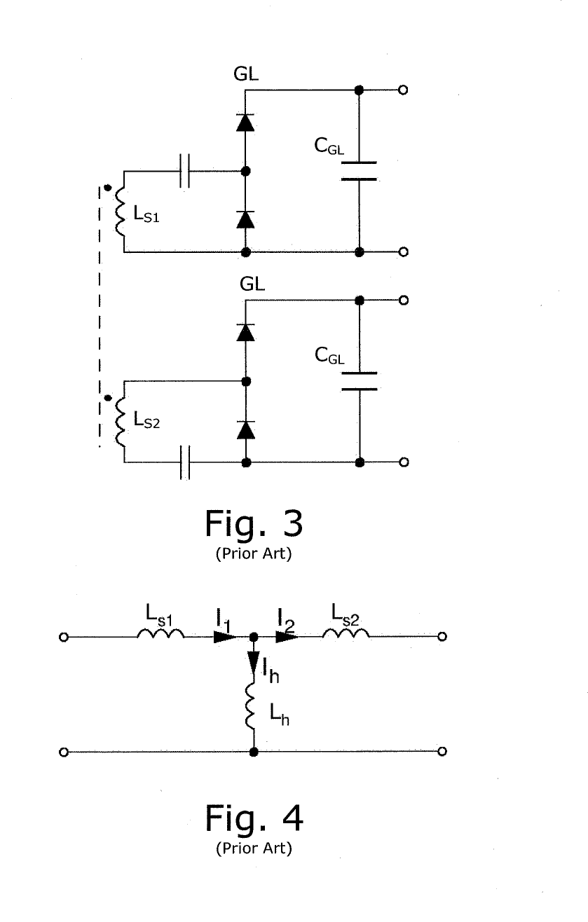

In order to decouple the coil currents I_{S1} and I_{S2}, the coils L_{S1} and L_{S2} can be interconnected, as depicted in FIG. 3. The coil currents I_{S1} and I_{S2} can comprise different phase positions and amplitudes in the case of this circuit and are rectified by the rectifier circuit GL and smoothed by the smoothing capacitor C_{GL}. In the case of this circuit, a vulnerability, however, results in the case of a horizontal offset of primary-side and secondary-side coil arrangement since due to the coupling of the coils L_{S1} and L_{S2}, it leads to an unbalance of the entire resonant circuit. FIG. 4 shows the equivalent circuit diagram for the circuit according to FIG. 3. As long as no horizontal offset relative to the optimal alignment of the primary-side and secondary-side coil arrangements exists, the magnetic circuit works in the push-pull operation and the current I₁ equal to minus I₂. The coils act, as if they were connected in series and have a positive feedback, wherein the entire inductance is greater than the sum of both partial inductances L_{S1} and L_{S2}.

However, as soon as the horizontal position of the primary and secondary-side coil arrangements deviates from the optimal position, the currents have a common mode portion, whereby the entire inductance is reduced since the coils comprise a negative feedback in the common mode operation. In the extreme case I₁=I₂, both currents mutually cancel each other in the main inductance, whereby I_{N}=and I₂=O. The entire inductance thus changes with the positioning of the secondary circuit over the primary circuit, whereby it leads to an unbalance of the resonant circuit and thus to a deterioration of the transfer properties.

The object of the present invention is thus to provide a solution for the above-mentioned problem.

This object is solved according to the invention in that either the primary-side coil system comprises two coils connected in series, the connection point of which is connected via a primary-side impedance with the centre point/centre tap of a voltage divider, or with the plus or minus pole of the intermediate circuit of the circuit suppling the primary-side resonant circuit, in particular in the form of a controlled inverter and/or in that the secondary-side coil system comprises two coils connected in series, the connection point of which is connected via a secondary-side impedance with the centre point/centre tap of a voltage divider or with the plus or minus pole of a circuit downstream of the secondary-side resonant circuit, in particular in the form of an rectifier.

The provision of an additional impedance according to the invention causes the inductance in the series resonant circuit of the primary and/or secondary-side coils connected in series to increase in the case of an offset to the optimal horizontal alignment, whereby an adaptation of the resonant frequency of the resonant circuit to the system frequency takes place.

The circuit supplying the primary-side resonant circuit is in this regard preferably a controlled bridge inverter, wherein each primary-side coil is connected in series with a capacity and forms a series resonant circuit with the latter and the series circuit of the series resonant circuits is connected to the AC voltage connection of the controlled bridge inverter. The impedance forms in this regard a centre tap between the primary-side coils and serves to adapt the resonant frequency of the primary-side resonant circuits to the system frequency.

The circuit downstream of the secondary-side resonant circuit is preferably a rectifier, in particular a bridge rectifier, wherein in the case of a bridge rectifier, each secondary-side coil is connected in series with a capacity and forms a series resonant circuit with the latter and the series circuit of the series resonant circuits is connected to the AC voltage connection of the bridge rectifier. The additional impedance forms in this regard a centre tap between the secondary-side coils and serves to adapt the resonant frequency of the secondary-side resonant circuits to the system frequency.

It is of course possible that both on the primary side as well as on the secondary side, in each case an additional impedance can be provided. It is also possible that an additional impedance is only provided on the secondary side or on the primary side. Generally, the additional impedance can be equal to the mutual inductance of the coils coupled to each other.

Below the invention is explained in greater detail by means of the Figures. They show:

FIG. 1a and 1b: Inductive energy transfer system with two secondary-side coils according to the prior art, in addition to equivalent circuit diagrams; FIG. 2: Possible interconnection of the secondary-side coils according to FIG. 1a;

FIG. 3: Decoupling circuit for coil arrangement according to FIG. 1b, in the case of horizontal offset;

FIG. 4: Equivalent circuit diagram for circuit according to FIG. 3;

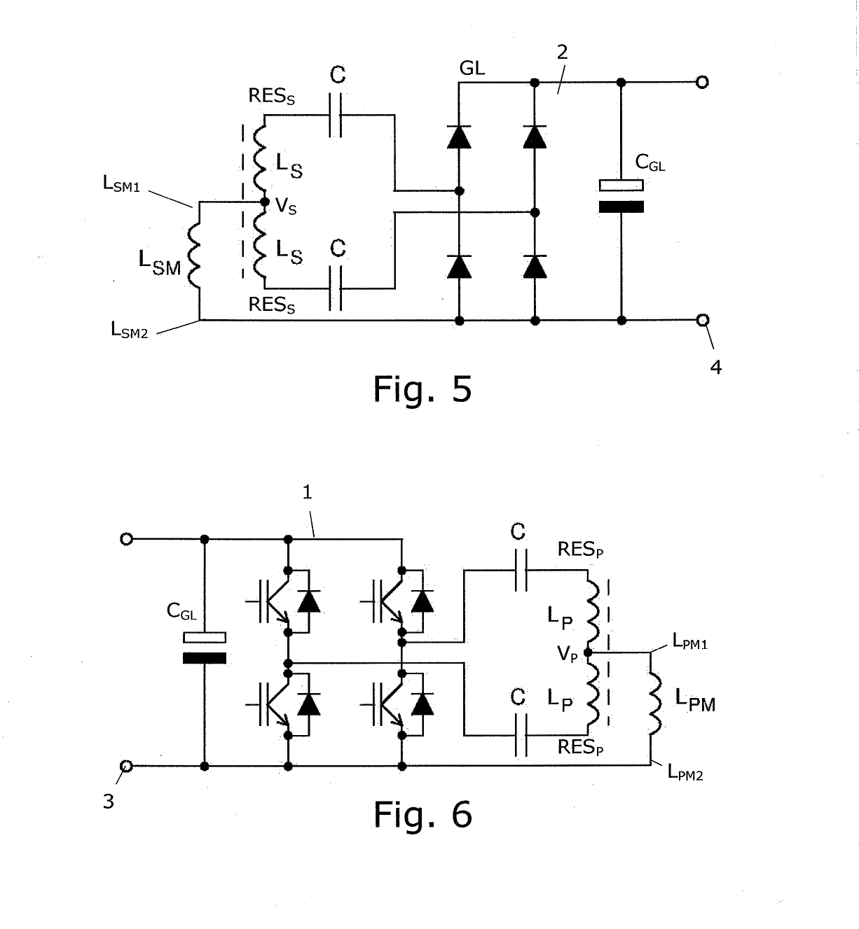

FIG. 5: Circuit according to the invention with additional impedance for secondary side of the inductive energy transfer system;

FIG. 6: Circuit according to the invention with additional impedance for primary side of the inductive energy transfer system;

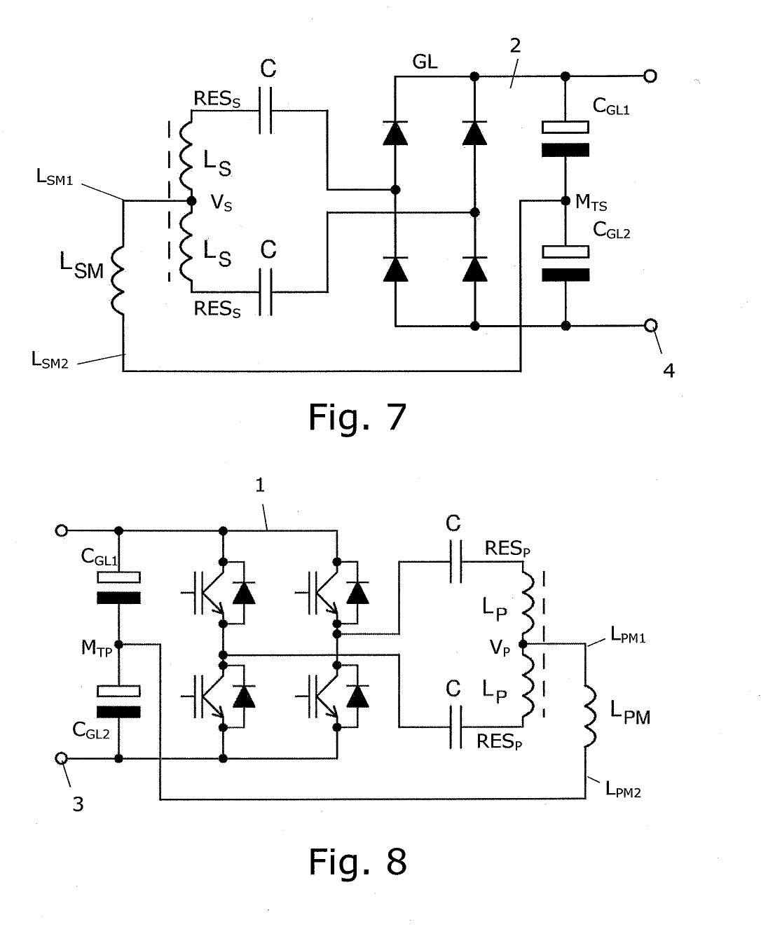

FIGS. 7 and 8: Circuits according to FIGS. 5 and 6, wherein additional impedance is connected to centre tap of a capacitive divider;

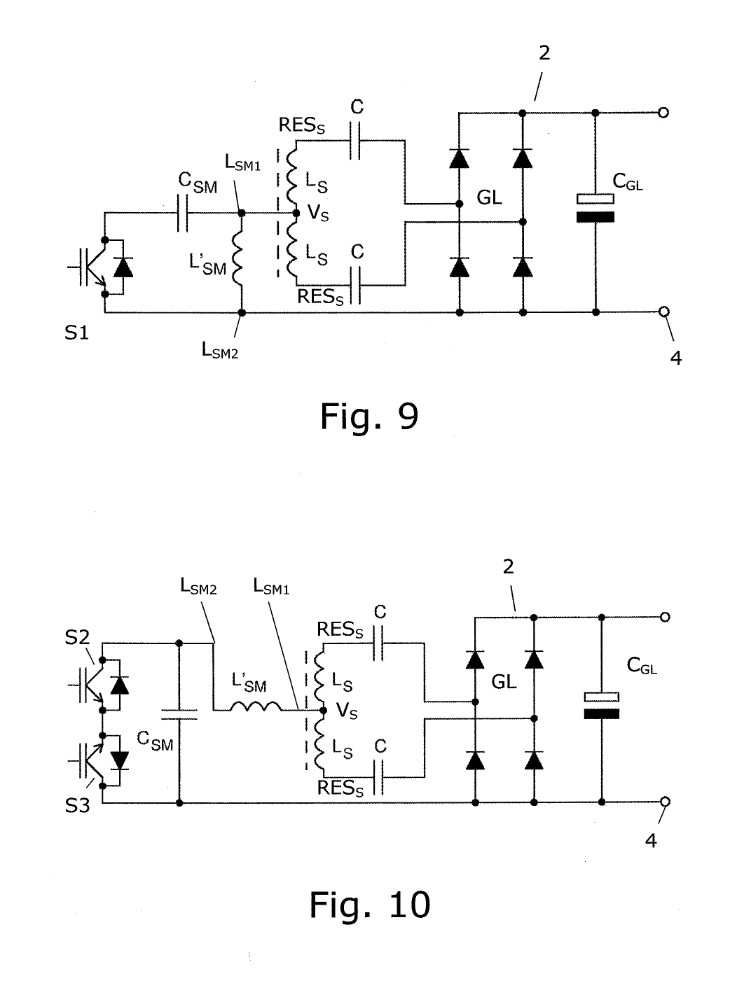

FIGS. 9 and 10: Circuits with additional changeable impedance for the secondary side of the inductive energy transfer system;

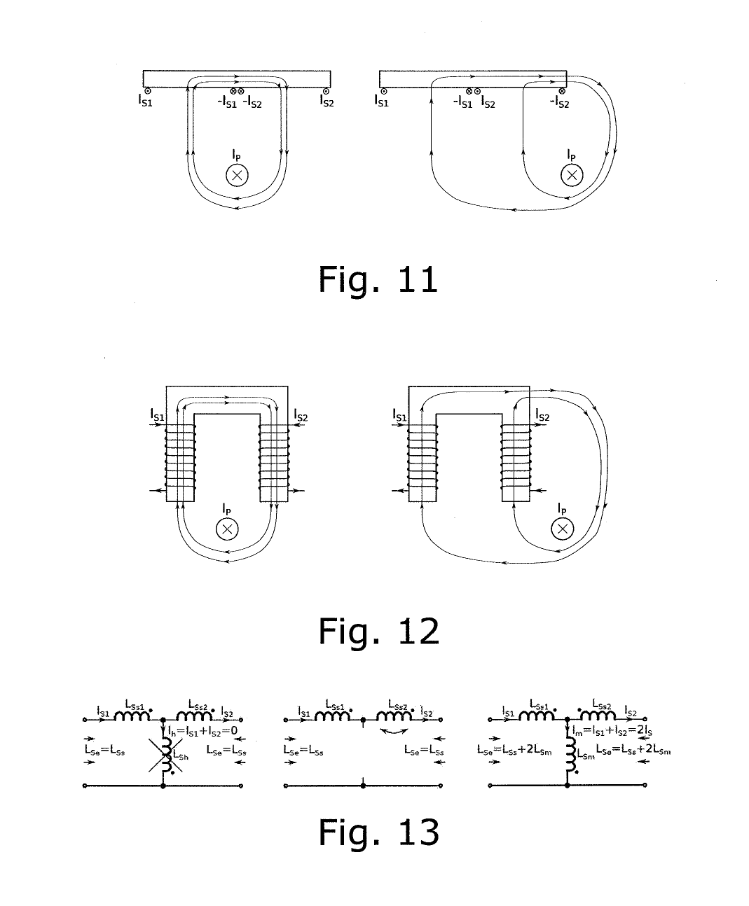

FIG. 11: Inductive energy transfer system according to the prior art with two planar secondary-side coils, which are arranged on a ferrite plate;

FIG. 12: Inductive energy transfer system according to the prior art of secondary-side U-Pickup;

FIG. 13: Equivalent circuit diagram for illustrating the inventive idea.

FIG. 5 shows a circuit according to the invention with additional impedance L_{SM} for the secondary side of the inductive energy transfer system, wherein the secondary-side coils L_{S} together with the capacitors C form series resonant circuits RES_{S}. The series circuit of the series resonant circuits RES_{S} is connected to the AC voltage connection of the rectifier GL. The additional impedance L_{SM} is connected with its one pole L_{SM1} to the connection point V_{S} and with its other pole L_{SM2} to the plus or minus pole (4) of the downstream rectifier GL.

FIG. 6 shows a circuit according to the invention with additional impedance L_{PM} for the primary side of the inductive energy transfer system, wherein the primary-side coils L_{P} together with the capacitors C form series resonant circuits RES_{P}. The series circuit of the series resonant circuits RESₚ is connected to the AC voltage connection of the inverter 1. The additional impedance L_{PM} is connected with its one pole L_{PM1} to the connection point V_{P} of the resonant circuits RES_{P} and with its other pole L_{PM2} to the plus or minus pole (3) of the intermediate circuit of the inverter 1 feeding the primary-side resonant circuit (RESₚ).

FIGS. 7 and 8 show circuits according to FIGS. 5 and 6, wherein the additional impedance L_{PM} or L_{SM} is not connected to a plus or minus pole, but to the centre tap M_{TP} or M_{TS} of a capacitive voltage divider C_{GL1}, C_{GL2}.

FIGS. 9 and 10 show developments of the circuit according to FIG. 5, which enable it to change the value or the secondary additional impedance L_{SM}. As depicted in FIG. 9, the capacitor C_{SM} can be connected parallel to the impedance L′_{SM} by means of the switching means S₁, as required. It is hereby possible to adapt the resonant frequency of the secondary resonant circuits RES_{S} in the case of different horizontal offsets between the primary and secondary coil arrangement of the primary-side frequency. Of course, it is possible to connect a plurality of capacitors in parallel, as required such that an even finer tuning of the resonant frequency is possible.

As is depicted in FIG. 10, it is also possible to connect a capacitor in series. This occurs by the switching means S₂, S₃ locking. Insofar as the capacitor C_{SM} should be disabled, the switching means S₂ and S₃ can be connected in a conductive manner.

FIGS. 11 and 12 show a flat pickup with planar coils as well as a U-shaped pickup in cooperation with a primary arrangement indicated as the line conductors. The depictions correspond to the FIGS. 1a and 1b, wherein the field lines and the ferrite cores are depicted for clarification.

FIG. 13 serves to explain the mode of action of the additional impedance. The magnetic T-equivalent circuit diagram for a common mode operation is depicted to the left. Through the common mode operation, the currents Is1 and Is2 cancel each other in the coils (see FIG. 1a) such that the inductance Lsh is dispensed with, as is depicted in the centre circuit diagram. The equivalent coil-inductance Leq is Ls1 and no longer Ls1+2Lsh as in the push-pull operation. The resonant capacitor is, however, designed for the push-pull operation such that an increase of the coil-inductance by 2Lsh is necessary here. This is implement by the “reverse” of one of the leakage inductances for the common mode operation in order to emulate the magnetic T-equivalent circuit diagram (depicted right) in a discrete circuit with an additional inductance Lsm. As a result, a circuit results, which, for the common mode operation, comprises the same impedance as the magnetic equivalent circuit diagram in the push-pull mode.

1. An inductive energy transfer system, comprising:
a primary-side coil arrangement; and
a secondary-side coil arrangement, wherein the primary-side coil arrangement and the secondary-side coil arrangement, together with respective capacitances, form respective resonant circuits;
(a) wherein a primary-side coil system comprises two coils connected in series, wherein a primary-side impedance is connected with a first pole to a connection point of one of the coils connected in series and with a second pole to a centre point/centre tap of a voltage divider, plus or minus pole of an intermediate circuit of a circuit arranged to supply the primary-side resonant circuit of a controlled bridge inverter; or
(b) wherein a secondary-side coil system comprises two coils connected in series, a connection point of which is connected via a secondary-side impedance to a centre point/centre tap of a voltage divider or to an output terminal of a circuit downstream of the secondary-side resonant circuit; or
both (a) and (b).

2. The inductive energy transfer system according to claim 1, wherein a respective primary-side coil is connected in series with a capacitance and forms a series resonant circuit with the capacitance, and wherein the series circuit of the series resonant circuits is connected to an AC voltage connection of the controlled bridge inverter.

3. The inductive energy transfer system according to claim 1, wherein the downstream circuit is a bridge rectifier.

4. The inductive energy transfer system according to claim 3, wherein a respective secondary-side coil is connected in series with a capacitance and forms a series resonant circuit with the capacitance, and wherein the series circuit of the series resonant circuit is connected to an AC voltage connection of the bridge rectifier.

5. The inductive energy transfer system according to claim 1, wherein the primary-side inductance forms a centre tap between the coils connected in series of the primary-side coil system, and wherein the primary-side inductance serves to adapt a resonant frequency of the primary-side resonant circuits to a system frequency.

6. The inductive energy transfer system according to claim 1, wherein the secondary-side inductance forms a centre tap between the coils connected in series of the secondary-side coil system, and wherein the inductance serves to adapt a resonant frequency of secondary-side resonant circuits to a system frequency.

7. The inductive energy transfer system according to claim 1, wherein in the case of optimal alignment to the primary-side coils, the secondary-side coils are magnetically coupled to the primary-side coils to the maximum extent, and wherein an entire inductance of the coupled primary-side and secondary-side coils is reduced in the case of a decreasing coupling between the primary and secondary-side coils, wherein a value of the primary-side impedance or a value of the secondary-side impedance, or both, is or are selected such that resonant frequency of the respective resonant circuit or circuits is or adapted to a system frequency.

8. The inductive energy transfer system according to claim 1, wherein the primary-side and secondary-side coils connected in each case in series comprise a same number of windings.

9. The inductive energy transfer system according to claim 1, wherein the primary-side impedance or the secondary-side impedance, or both, is formed by a respective resonant circuit.

10. The inductive energy transfer system according to claim 1, wherein primary-side impedance is equal to a mutual inductance of the primary-side coils connected in series.

11. The inductive energy transfer system according to claim 1, wherein the secondary-side impedance comprises a value between a value of a mutual inductance of the secondary-side coils connected in series and twice the value of the mutual inductance of the secondary-side coils connected in series.

12. The inductive energy transfer system according to claim 11, wherein the secondary-side impedance is changeable by at least one closed or short circuit series inductance or by at least one parallel capacitor switchably connectable in parallel or in series to the secondary-side impedance, or by both at least one closed or short circuit series inductance and by at least one parallel capacitor connected in parallel or in series to the secondary-side impedance.
